(19) United States
(12) Patent Application Publication
(10) Pub. No.: US 2012/0300796 A1
(43) Pub. Date: Nov. 29, 2012

(54) HYBRID LASERS

(76) Inventors: Matthew N. Sysak, Santa Barbara, CA (US); Richard Jones, San Mateo, CA (US); Eugenia D. Eugenieva, Santa Clara, CA (US)

(21) Appl. No.: 13/118,202

(22) Filed: May 27, 2011

(51) Int. Cl. H01S 3/30

(52) U.S. Cl. 372/6

(57) ABSTRACT

Embodiments of the invention provide electrically pumped hybrid semiconductor lasers that are capable of being integrated into and with silicon-based CMOS (complementary metal-oxide semiconductor) devices. Hybrid laser active regions are comprised of multiple quantum wells or quantum dots. Devices according to embodiments of the invention are capable of being used to transfer data in and around personal computers, servers, and data centers as well as for longer-range data transmission.

### BACKGROUND OF THE INVENTION

1. Field of the Invention

The embodiments of the present invention relate generally to optical interconnects, optical communication and data transfer, lasers, hybrid semiconductor lasers, and silicon photonics.

2. Background Information

Data transmission and communication using optical-based technologies offers advantages over standard electrical conductor-based systems in many situations. Lasers can produce the light (electromagnetic radiation) on which data may be encoded and transmitted. In general, a laser is a device that produces coherent light through an optical amplification process based on the stimulated emission of photons. The light produced by a laser can be, for example, electromagnetic radiation in the infrared, visible, ultraviolet, or X-ray region of the electromagnetic spectrum. A typical laser consists of a reflective optical cavity surrounding a gain medium and a means to supply energy to the gain medium. The gain medium is a material that emits light in response to energy supplied to the gain medium. A laser can be pumped (i.e., energy can be transferred from an external source to the gain medium) using electrical energy and or light energy.

There is a need for improved optical devices in order to more fully realize the potential advantages of high speed optical data transmission. Applications include optical data transmission inside and around personal computers, servers, and data centers as well as more long-range data transmission and communication activities.

### BRIEF DESCRIPTION OF THE FIGURES

FIG. 1 shows a hybrid semiconductor laser.

FIG. 2 illustrates an additional structure for a hybrid semiconductor laser.

FIG. 3 illustrates an active region for a hybrid semiconductor laser.

FIG. 4 provides an additional structure for a semiconductor silicon laser employing quantum dots.

FIG. 5 shows a structure manufactured on a GaAs epitaxial wafer and useful for forming a hybrid laser having an active region comprised of GaAs quantum dots.

FIGS. 6A-C show waveguide structures useful for hybrid semiconductor lasers.

FIG. 7 illustrates a system useful for optical data transmission.

### DETAILED DESCRIPTION OF THE INVENTION

Embodiments of the present invention provide electrically pumped hybrid semiconductor lasers. These hybrid semiconductor lasers are capable of being integrated into and with silicon-based CMOS (complementary metal-oxide semiconductor) devices. Embodiments of the invention provide lasers having improved power output stability through the restriction of the laser to a single transverse lasing mode. In other words, a plot of laser output power as a function of bias current into the active region (the region that produces light) of the laser is a smooth curve without irregular spikes. Devices according to embodiments of the invention are capable of being used to transfer data in and around personal computers, servers, and data centers as well as for longer-range data transmission.

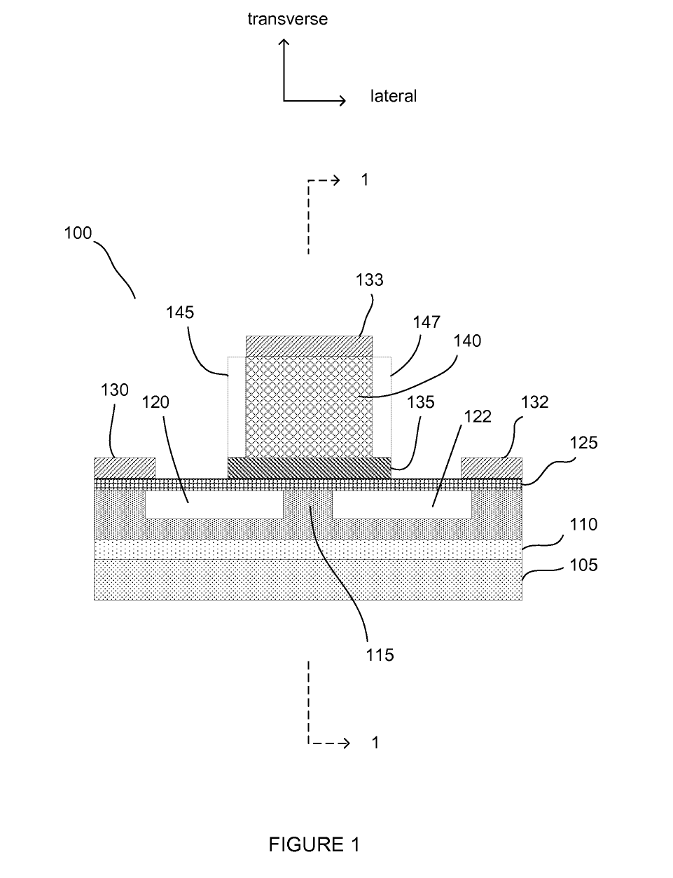

FIG. 1 provides a hybrid semiconductor evanescent laser that is capable of being electrically and optically pumped. In FIG. 1, the laser structure 100 is formed on a substrate 105 having a layer of insulator 110. The substrate 105 is, for example, silicon, and the layer of insulator 110 is, for example, silicon dioxide. A waveguide structure 115 is, for example, epitaxial silicon, P- or N-doped silicon, amorphous silicon, or poly silicon. The waveguide structure 115 is surrounded on two sides with regions 120 and 122 that contain a material that has a lower index of refraction than that of the waveguide 115 material. In FIG. 1, the waveguide 115 is a rib waveguide. Other structures and or shapes for the waveguide structure 115 are possible, such as, for example, strip waveguides, and circular waveguides, as are known in the art. The material in regions 120 and 122 is, for example, a gas, such as air, or an inert gas, such as argon or nitrogen, in which case, regions 120 and 122 can also be considered empty spaces. In other embodiments, the material in regions 120 and 122 is silicon dioxide, silicon nitride, silicon oxynitride, SU8 (a commercially available epoxy-based negative resist) BCBs (benzocyclobutene-based polymers), or spin-on glass (SOG). A first connection layer (e.g., a metal n diode contact layer) 125 electrically connects the electrical contacts 130, 132, and 133 to the active region 135 of the laser structure. In an embodiment of the invention, the laser 100 is integrated into a structure (not shown) that provides current to electrical contacts 130 and 132. A current path exists through the first connection layer 125 into the active region 135 and out through the cladding layer(s) 140 to electrical contact 133. The first connection layer 125 is, for example, an N—InP. An N—InP is for example, a Si doped indium phosphide, such as a 3e18 cm⁻³ Si doped InP. Other materials the first connection layer 125 could be formed from include, for example, doped layers comprising elements from groups III and V of the periodic table. The electrical contacts 130, 132, and 133 are comprised, for example, of a metal such as, for example, Au, Pt, Cu, and or Al. The cladding region 140 is comprised, for example, of P-type indium phosphide and is typically formed as a plurality of layers. The cladding region 140 is, for example, Zn doped InP, and is a material such as 1e18 cm⁻³ Zn doped InP. The cladding 140 has insulating regions 145 and 147 that define a current path through cladding 140 between the active region 135 and the electrical contact 133. The cladding region 140 abuts insulating regions such as regions 145 and 147 on sides not abutting electrical contact regions 133 and active region 135. The current path is created, for example, through a process that etches the cladding 140. Insulating regions 145 and 147 are comprised of an insulating material, such as, for example, air, silicon dioxide, silicon oxynitride, silicon nitride, BCB, SU8, and or SOG. Insulating regions 145 and 147 are not comprised of doped or implanted cladding material, such as indium phosphide implanted with protons (H⁺) formed, for example, through an implantation process carried out on the edges of the cladding 140. Insulating regions 145 and 147 are optionally a passivation layer or part of a passivation layer (not shown) that is formed over some or all of laser 100. A passivation layer protects the device and is typically a layer of oxide, such as silicon dioxide, or nitride, such as silicon nitride or silicon oxynitride. In an embodiment, in operation, electrical contacts 130 and 132 are negatively biased and electrical contact 133 is positively biased as voltage is applied to the contacts and current flows through the active region 135.

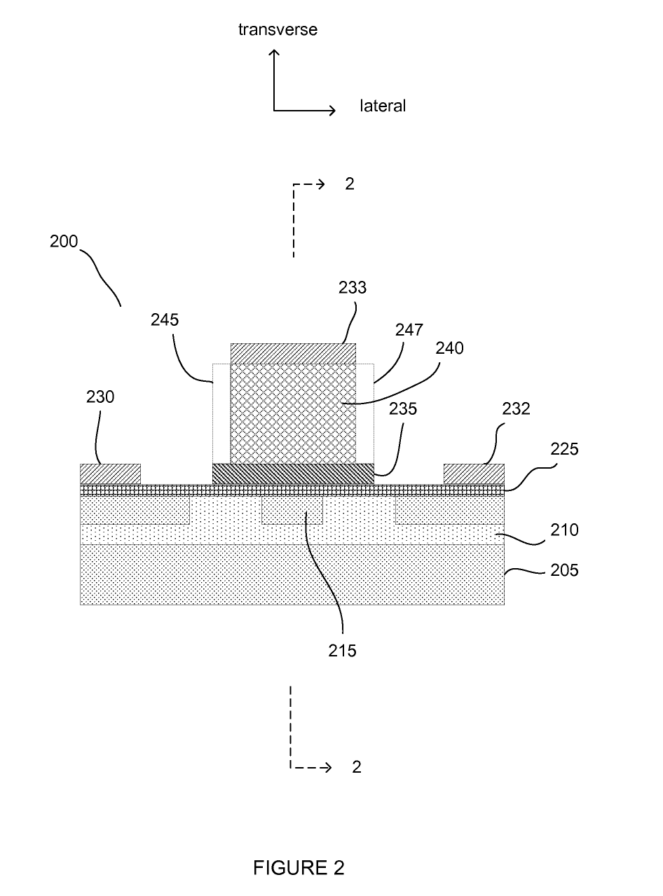

FIG. 2 provides an additional structure for a hybrid semiconductor evanescent laser that is capable of being electrically and optically pumped. In FIG. 2, the laser structure 200 is formed on a substrate 205 having a layer of insulator 210, such as, for example, a buried oxide layer (silicon dioxide), silicon oxynitride, or silicon nitride. The substrate 205 is, for example, silicon. The waveguide 215 is typically comprised of epitaxial silicon, P- or N-doped silicon, amorphous silicon, or poly silicon. The waveguide structure 215 is surrounded on at least three sides with region 210 that comprises a material that has a lower index of refraction than that of the waveguide 215 material. A first connection layer (e.g., a metal n diode contact layer) 225 electrically connects the electrical contacts 230, 232, and 233 to the active region 235 of the laser structure. In an embodiment of the invention, the hybrid laser 100 is integrated into a structure (not shown) that allows current to be supplied using electrical contacts 230 and 232 through the first connection layer 225 into the active region 235 and through the cladding layer(s) 240 to electrical contact 233. The first connection layer 225 is, for example, an N—InP. An N-type InP is for example a Si doped indium phosphide, such as a 3e18 cm⁻³ Si doped InP. Other materials the first connection layer 225 can be formed from include, for example, doped layers comprising elements from groups III and V of the periodic table. The electrical contacts 230, 232, and 233 are comprised, for example, of a metal such as, for example, Au, Pt, Cu, and or Al. The cladding region 240 is comprised, for example, of P-type indium phosphide and is typically formed as a plurality of layers. The cladding region 140 is, for example, Zn doped InP, and is a material such as 1e18 cm⁻³ Zn doped InP. The cladding 240 has insulating regions 245 and 247 that define a current path through cladding 240 between the active region 235 and the electrical contact 233. The current path is created, for example, through a process that etches the cladding 140. Insulating regions 245 and 247 are comprised of an insulating material, such as, for example, air, silicon dioxide, silicon oxynitride, silicon nitride, BCB, SU8, and or SOG. Insulating regions 245 and 247 are not comprised of doped or implanted cladding material, such as indium phosphide implanted with protons (H⁺), for example, through an implantation process carried out on the edges of the cladding 240. Insulating regions 245 and 247 are optionally a passivation layer or part of a passivation layer (not shown) that is formed over some or all of laser 200. A passivation layer protects the device and is typically a layer of oxide, such as silicon dioxide, or nitride, such as silicon nitride or silicon oxynitride. In an embodiment, in operation, electrical contacts 230 and 232 are negatively biased and electrical contact 233 is positively biased as voltage is applied to the contacts and current flows through the active region 235.

In general, the active region of a laser is the source of optical gain within the laser that results from the stimulated emission of photons. The emission of photons is stimulated by energy input from the pump source. The structure of the active region is a factor in determining the resulting the modal properties of the hybrid silicon waveguide laser structure. Multiple modes in the laser are less desirable than a single mode because multiple modes can lead to laser output power noise and instability which often manifest as kinks in the power output versus current input curve for the laser.

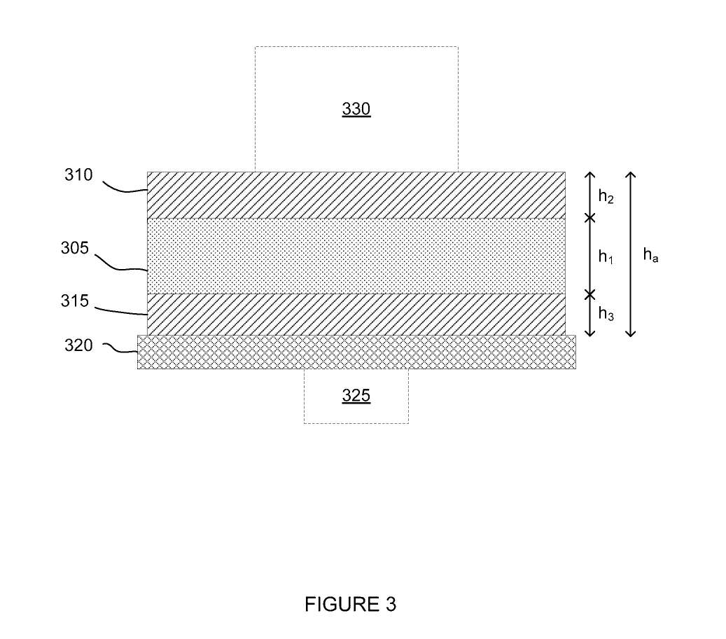

FIG. 3 shows an active region (the gain medium or lasing medium) of a hybrid silicon laser according to embodiments of the invention, including those shown in FIGS. 1 and 2. In FIG. 3, the active region comprises a light-emitting region 305 and two proximate separate confinement layers (SCH) 310 and 315. The light-emitting region 305 is comprised of a multiple quantum well (MQW) region comprised of a group III V material (a material comprising elements from group IIIA and group VA of the periodic table), such as for example, AlGaInAs, InAlGaAs, GaAs/GaAlAs and or InGaAsP. In general, quantum wells are regions in which particles (e.g., electrons and electron holes) are essentially confined to two dimensions causing the particles to adopt discrete energy values. The confinement in two dimensions occurs through the reduction in thickness of the quantum well region. Quantum wells are formed by sandwiching a material having a lower bandgap between a material having a wider bandgap. For example, quantum wells consist of a layer of GaAs between two layers of AlAs or a layer of GaAs between two layers of GaAlAs. Quantum well layers can be formed, for example, using molecular beam epitaxy or chemical vapor deposition techniques. Multiple quantum well lasers comprise a plurality of quantum well layers. In general, the separate confinement layers 310 and 315 are layers of material that have a lower refractive index than the multiple quantum well region 305. SCH layers 310 and 315 are comprised of a III-V material, such as for example, AlGaInAs, InGaAsP, and or GaAs. Optionally SCH layer 310 is comprised of a different material than SCH layer 315. Further optionally, the SCH layers 310 and 315 are P- or N-type layers. A connection layer 320 and a waveguide 325 and cladding region 330 are shown for reference.

The height of the active region, hₐ, of FIG. 3, is a value that results in an active region that is unable to support a mode. In general, a mode can be considered to be an electric field distribution that propagates along a waveguide with constant distribution, i.e., the electric field distribution does not vary as it propagates. A guided mode propagates without diffraction. A method for determining the whether an active region is able to support a mode for a slab waveguide is provided by the equation:

$${v}_{c , TE } = \frac{m π}{2} + \frac{1}{2} atan \sqrt{γ} \qquad ( 1 )$$

in which γ is a measure for asymmetry and is given by the equation: γ=(nₛ²−n_{c}²)/(n₁²−nₛ²) where nₛ is the refractive index of a proximate layer or substrate, such as the connection layer 320, n₁ is the refractive index of the core (active region), and n_{c} is the refractive index of the cladding material; m is the mode number, and v_{c,TE} is the cutoff frequency for the TE modes, the TE modes are the transverse electrical optical modes. A slab waveguide consists of three main regions: a core with refractive index n₁, a substrate with refractive index nₛ, and cladding with refractive index n_{c}. In general, the relation between the three refractive indexes is n₁>nₛ>n_{c}. Solutions to equation (1) for m equal to zero (m=0) provide a value for the cutoff frequency, v_{c,TE}. Normalized frequency, v, is a quantity which depends on the optical wavelength and waveguide geometry. If the thickness of an optical waveguide is 2a, normalized frequency, v, is defined as:

$$v = \frac{2 π}{λ} = a \sqrt{{n}_{1}^{2} - {n}_{2}^{2} } \qquad ( 2 )$$

where λ is the wavelength of light (an electromagnetic wave) emitted by the core region, n₁ is the refractive index of the core region, and nₛ is the refractive index of the substrate or other proximate layer. If waveguide normalized frequency, v, is bigger than the cutoff frequency for mode m, mode m exists. Therefore, in embodiments of the invention, the waveguide normalized frequency, v, is smaller than the cutoff frequency, v_{c,TE}, for m=0 (equation (1)), a condition that is created by limiting the waveguide thickness (active region height, hₐ) to values that make v<v_{c,TE}. In this invention the slab waveguide is designed such that it does not support any modes. The waveguide thickness correlates to the active region height in FIG. 3. However, once the heterostructure that is the active region is joined to a semiconductor waveguide structure it does support at least a single mode.

In FIG. 3, the height of the active region, hₐ, is the sum of the heights (thicknesses) of the light-emitting region 305, h₁, and the heights of the SCH layers 310 and 315, h₂ and h₃. In embodiments of the invention, the refractive index of the SCH layers 310 and 315, is a value between and including 3.2 to 3.3. In further embodiments of the invention, the index of refraction of the light-emitting region 305 is 3.5. Other values are also possible and depend on the composition of the layers that make up the active region. In embodiments of the invention, for active regions having indices of refraction values between 3.3 and 3.5, the height of the active region, hₐ, is a value between and including 40 nm to 400 nm. In alternate embodiments, the height of the active region, hₐ, is a value between and including 50 nm and 340 nm or a value between and including 70 nm and 330 nm. For example, if the refractive index of the active region is 3.34 the thickness of the active region is less than 400 nm, if the refractive index of the active region is 3.4 the thickness of the active region is less than 160 nm, if the refractive index of the active region is 3.5 the thickness of the active region is less than 80 nm. In embodiments of the invention, the height of the light-emitting region 305, h₁, is a value between 7 nm and 80 nm. In embodiments of the invention, the height of the SCH layers 310 and 315, h₂ and h₃, is a value between and including 20 nm and 200 nm. Optionally, the SCH layers 310 and 315 are the same thicknesses or different thicknesses. In embodiments of the invention, the SCH layers 310 and 315 have a refractive index value between and including 3.1 and 3.4.

The hybrid laser structures of FIGS. 1-3 are created, for example, through, for example, flip-chip bonding or wafer bonding of the active region structure to the waveguide. Alternately, the hybrid laser structures are formed through epitaxial deposition processes.

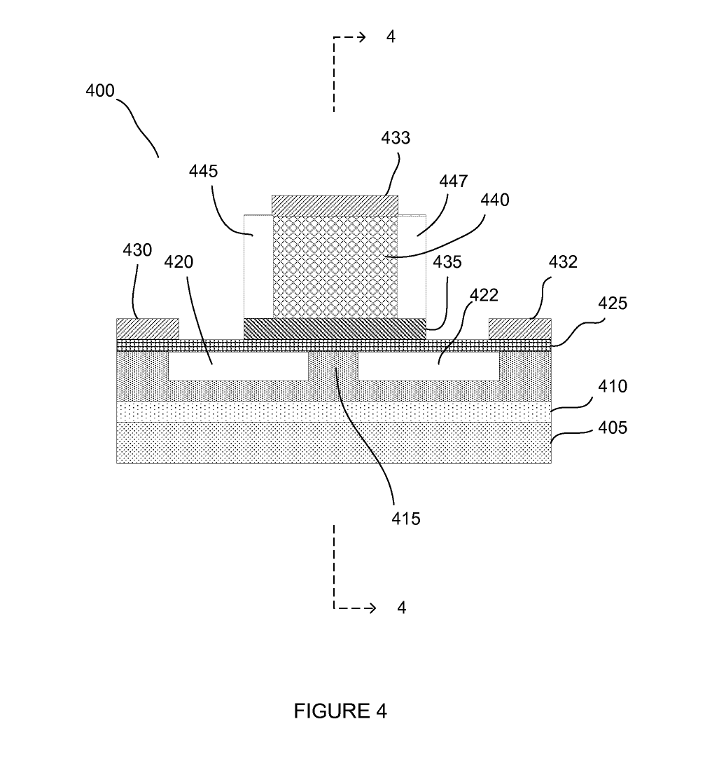

FIG. 4 illustrates a hybrid semiconductor laser capable of being electrically pumped that employs quantum dots in the laser active region. In FIG. 4, the laser structure 400 is formed on a substrate 405 having a layer of insulator 410. The substrate 405 is, for example, silicon, and the layer of insulator 410 is, for example silicon dioxide. A waveguide structure 415 is, for example, epitaxial silicon. The waveguide structure 415 is surrounded on two sides with regions 420 and 422 that are a material that has an index of refraction that is different from that of the waveguide 415 material. In FIG. 4, the waveguide 415 shown is a rib waveguide. Other structures and or shapes for the waveguide structure 415 are possible, such as, for example, strip waveguides and circular waveguides, as are known in the art. The material in regions 420 and 422 is, for example, a gas, such as air, or an inert gas, such as argon or nitrogen, in which case, regions 420 and 422 can also be considered empty spaces. In other embodiments, the material in regions 420 and 422 is silicon dioxide, silicon nitride, silicon oxynitride, BCB, SU8, and or SOG. A first connection layer (e.g., a metal N diode contact layer) 425 electrically connects the electrical contacts 430, 432, and 433 to the active region 435 of the laser structure. In an embodiment of the invention, the laser 400 is integrated into a structure (not shown) that allows current to be injected using electrical contacts 430 and 432 through the first connection layer 425 into the active region 435 and out through the cladding layer(s) 440 to electrical contact 433. The first connection layer 425 is comprised of, for example, a N-type GaAs. An N-type GaAs is for example, a silicon doped gallium arsenide such as 5e18 cm⁻³ Si doped GaAs. Other materials the first connection layer 425 could be formed from include, for example, doped layers comprising elements from groups III and V of the periodic table. The electrical contacts 430, 432, and 433 are, for example, a metal such as, for example, Au, Pt, Cu, and or Al. The cladding region 440 is, for example, P-type GaAs or AlGaAs and is typically formed as a plurality of layers. A P-type AlGaAs is doped with, for example, Be, such as 5e17 cm⁻³ Be AlGaAs. The cladding 440 has insulating regions 445 and 447 that define a current path through cladding 440 between the active region 435 and the electrical contact 433. The cladding region 440 abuts insulating regions such as regions 445 and 447 on sides not abutting electrical contact regions 433 and active region 435. The current path is created, for example, through etching the cladding 440. In embodiments of the invention, there is no metal layer between the waveguide 415 and the active region 435. Insulating regions 445 and 447 are comprised of an insulating material, such as, for example, air, silicon dioxide, silicon oxynitride, silicon nitride, BCB, SU8, or SOG. Insulating regions 445 and 447 are optionally a passivation layer or part of a passivation layer (not shown) that is formed over some or all of laser 400. A passivation layer protects the device and is typically a layer of oxide, such as silicon dioxide, or nitride, such as silicon nitride or silicon oxynitride. In alternate embodiments, insulating regions 445 and 447 are doped or implanted cladding material, such as GaAs or AlGaAs implanted with protons (H⁺) that is formed, for example, through an implantation process carried out on the edges of the cladding 440. In an embodiment, in operation, electrical contacts 430 and 432 are negatively biased and electrical contact 433 is positively biased as voltage is applied to the contacts and current flows through the active region 435. Optionally, the active region 435 includes SCH layers.

The active region 435 for the laser of FIG. 4 is comprised of quantum dots that are comprised of GaAs, InAs, or InGaAs. In an embodiment of the invention, the quantum dots are comprised of GaAs. In a further embodiment of the invention, the quantum dots are comprised of InGaAs. In general, quantum dots are small crystals of a semiconductor material in which states for electrons and holes are quantized through confinement in three spatial dimensions. The electronic characteristics of a quantum dot are related to the size and shape of the quantum dot particle. Quantum dots can be made, for example, either through self-assembly deposition processes or through molecular beam epitaxy techniques or metal-organic chemical vapor deposition techniques. In embodiments of the invention, quantum dots are used instead of quantum wells in the active regions of the laser structures of FIGS. 1-3.

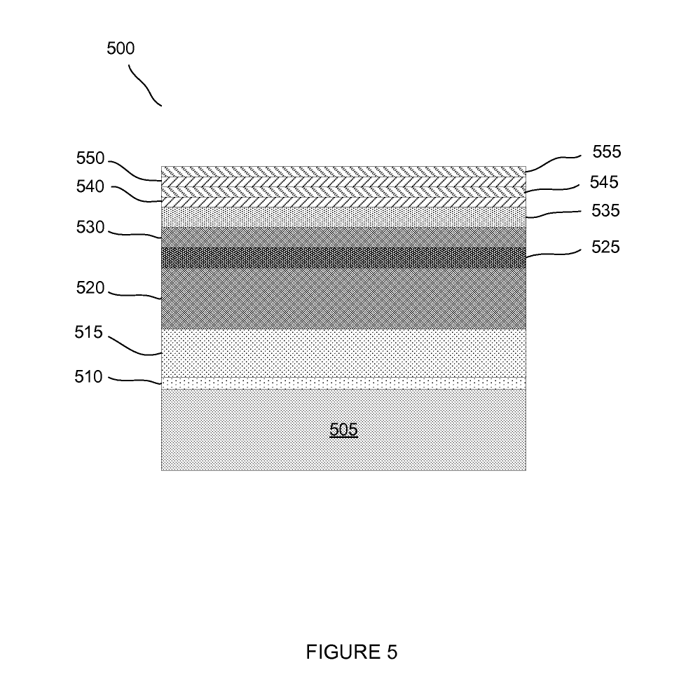

FIG. 5 shows a quantum dot III-V epitaxial structure useful for manufacturing a hybrid laser having an active region comprise of GaAs quantum dots. In FIG. 5, a GaAs epitaxial substrate 505 has an AlGaAs etch stop layer 510, a GaAs P-cladding layer 515 (P-type GaAs comprises, for example a Be dopant, such as 5e18 cm⁻³ of Be doping), an AlGaAs P-cladding layer 520 (P-type AlGaAs comprises, for example, a Be dopant, such as 5e17 cm⁻³ of Be), a GaAs quantum dot active region 525, a N—AlGaAs layer 530 (a N-type AlGaAs comprises, for example, a Si dopant, such as 5e18 cm⁻³ Si), a N—GaAs layer 535 (a N-type GaAs comprises, for example, a Si dopant, such as 5e18 cm⁻³ Si), and regions 540-555 that are comprised of AlGaAs/GaAs superlattice material. The structure of FIG. 5 is bonded to a silicon-on-insulator (SOI) wafer that has etched waveguides with the quantum dot laser portion of structure 500 proximate to the silicon waveguide structure. Bonding of the AlGaAs/GaAs superlattice to the waveguide structure can occur, for example, through the formation of a semiconductor layer on the AlGaAs/GaAs superlattice material. In embodiments of the invention, a metal layer is not used in joining the two structures together. Following bonding, the GaAs substrate is removed, mesas are patterned, and quantum dots etched. After mesa formation, implant metal is deposited on the tops of the mesas and the structure is subjected to a proton implantation process. The proton implantation process creates current confinement in the P-type GaAs cladding region. In an alternate embodiment, the current confinement in the cladding region is achieved by etching the sides of the cladding region. After implantation, N contact metal is deposited.

In general, a waveguide consists of a core and a cladding or substrate at least partially surrounding the core. The refractive index of the core material is higher than that of the surrounding material (the cladding). A waveguide acts a router for light waves through total internal reflection within the core. Waveguides are transparent at the wavelengths at which optical communications operate, such as for example, infrared wavelengths. The light generated in the active region of the lasers according to embodiments of the invention couples directly into the waveguide structures.

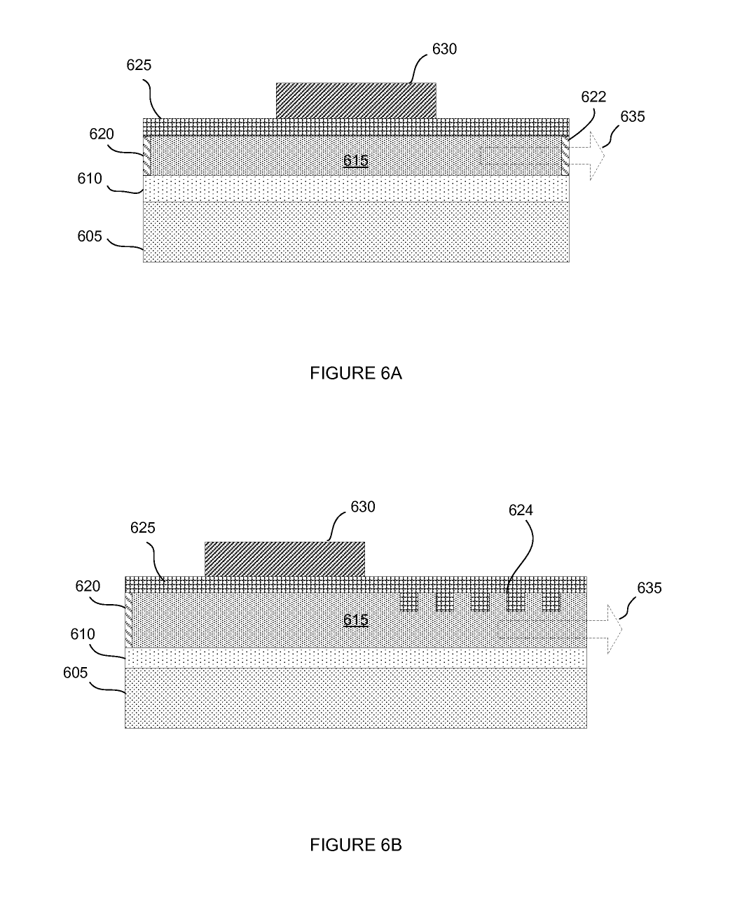

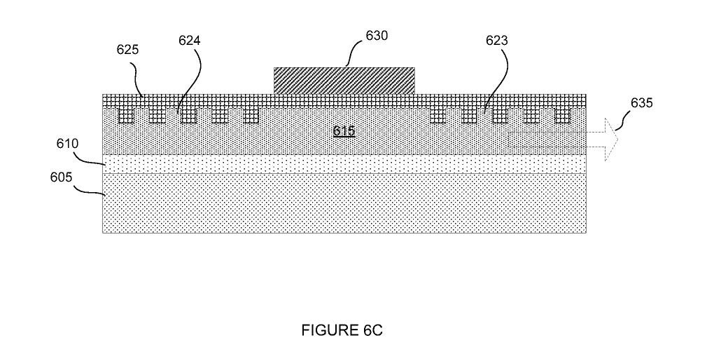

FIGS. 6A-C provide several different waveguide structures useful in embodiments of the invention, such as those described with respect to FIGS. 1-5. The waveguides of FIGS. 6A-C are capable of acting as laser cavities (or optical cavities) for a hybrid silicon laser. Other optical cavity structures are also possible as understood by those of skill in the art. FIGS. 6A-C show structures that are rotated 90 degrees and sliced along a lateral centerline (1-1, 2-2, and 4-4, respectively) with respect to the structures shown in FIGS. 1, 2, and 4. In FIG. 6A, a substrate 605 houses a layer of insulator 610 (which would not be present for a device according to FIG. 1) and the waveguide 615. Waveguide 615 has regions in which light is reflected 620 and 622. Light reflection regions are created, for example, by polishing the waveguide surface or providing a coating to the surface of the waveguide 415 in the light reflection region(s) 620 and or 622. A connection layer 625 and an active region 630 are shown for reference. The light-emitting region of the hybrid laser is optically coupled to the waveguide and light that is generated in the light-emitting region of the hybrid laser is capable of entering the waveguide. The reflection layer 622 allows some light to exit the laser device (as indicated by the arrow 635). In FIG. 6B, features are the same as indicated for FIG. 6A, except that the light reflection region 622 is a grating 623. Similarly, in FIG. 6C, features are the same as indicated for FIG. 6A, except that the light reflection regions 620 and 622 are gratings. In an embodiment of the invention, useful dimensions for the waveguides are a height of 0.4 μm, a rib depth of 0.2 μm and a width of 0.5-1 μm.

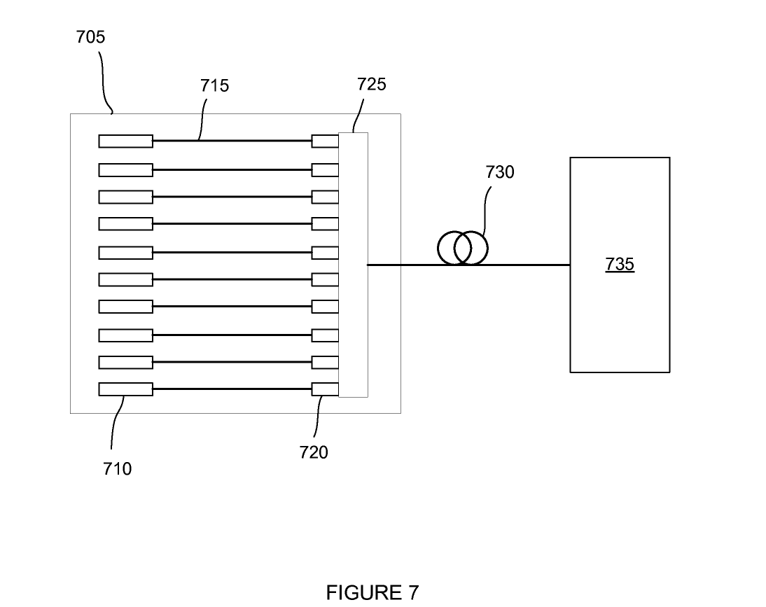

FIG. 7 provides a system that can be used to transmit data optically. In FIG. 7, an integrated circuit chip 705 comprises a plurality of hybrid silicon lasers 710 according to embodiments of the invention. Although ten hybrid lasers 710 are shown, the hybrid silicon lasers are capable of compact dimensions that allow the integration of many more hybrid lasers onto a single chip. As few hybrid lasers 710 as one hybrid laser on a chip is also possible. Optionally, the hybrid silicon lasers output different wavelengths of light through the modification of the properties of the associated waveguides. In other embodiments, the use of quantum dots allows the variation of the laser output wavelengths through the modification of the size of the quantum dots. The hybrid silicon lasers are capable of integration with other components of the system on the integrated circuit chip. Some or all of the components of the system of FIG. 7 are optionally integrated into a single semiconductor chip. The electrical control/pump circuits for the hybrid lasers (not shown) are optionally integrated directly onto the substrate on which the laser is formed. Waveguides 715 optically connect the hybrid lasers 710 to optical modulators 720 that encode information. Light output is then capable of passing to the multiplexer 725 which channels the output of the hybrid lasers 710 into a waveguide 730. Optionally, waveguide 730 is a single fiber. Optical receiver 735 is capable of receiving the light output from the waveguide 730. Optical receiver 735 is comprised of a demultiplexer (not shown) that splits the input light signal from waveguide 730 into component wavelengths that are carrying information, a plurality of waveguides (not shown) optically coupled to the demultiplexer, and a plurality of detectors (not shown) optically coupled to and capable of detecting the light from the waveguides of receiver 735. The component wavelengths are directed through a plurality of waveguides into detectors that are capable of detecting light. The detectors are, for example, SiGe photodetectors.

The substrate on which the devices according to embodiments of the invention are built is, for example, a silicon wafer or a silicon-on-insulator substrate. Silicon wafers are substrates that are typically used in the semiconductor processing industry, although embodiments of the invention are not dependent on the type of substrate used. The substrate could also be comprised of germanium, indium antimonide, lead telluride, indium arsenide, indium phosphide, gallium arsenide, gallium antimonide, and or other Group III-V materials either alone or in combination with silicon or silicon dioxide or other insulating materials. Devices that make up a laser and associated electronics are built on the substrate surface. Additionally, the substrate optionally houses electronics that are capable of performing or assisting in the performance of computing functions, such as data input, data processing, data output, and data storage.

Persons skilled in the relevant art appreciate that modifications and variations are possible throughout the disclosure and combinations and substitutions for various components shown and described. Reference throughout this specification to “one embodiment” or “an embodiment” means that a particular feature, structure, material, or characteristic described in connection with the embodiment is included in at least one embodiment of the invention, but does not necessarily denote that they are present in every embodiment or all present in the same embodiment. Furthermore, the particular features, structures, materials, or characteristics may be combined in any suitable manner in one or more embodiments. Various additional layers and/or structures may be included and/or described features may be omitted in other embodiments.

We claim:

1. An apparatus comprising,
an optical waveguide structure,
a light-emitting region comprised of semiconductor material that is capable of emitting light in response to the input of electrical energy, wherein the light-emitting region is optically coupled to the waveguide so that the light-emitting region is capable of transmitting light to the optical waveguide, and
a first separate confinement heterostructure layer between the optical waveguide and the light-emitting region and a second separate confinement heterostructure layer proximate to the light-emitting region and on an opposite side of the light-emitting region from the first separate confinement heterostructure layer,
wherein the first separate confinement heterostructure layer, the light-emitting region, and the second separate confinement heterostructure layer make up an active region of the laser and the active region does not support a mode.

2. The apparatus of claim 1 wherein the waveguide structure is comprised of silicon.

3. The apparatus of claim 1 additionally including a cladding region proximate to the active region and on a side of the active region opposite the optical waveguide wherein the cladding region partially defines a path for current flow between the active region and an external source of voltage.

4. The apparatus of claim 3 wherein the path for current flow is defined by boundaries of the cladding region and not in part or fully by a hydrogen implant region that is part of the cladding region.

5. The apparatus of claim 3 also including and an electrical connection layer between the active region and the optical waveguide wherein the electrical connection layer further defines the path for current to flow between the active region and an external source of voltage.

6. The apparatus of claim 1 wherein the active region is comprised of multiple quantum wells.

7. The apparatus of claim 1 wherein the active region is comprised of multiple quantum wells that are comprised of InGaAs, AlGaAs, or InAlGaAs.

8. The apparatus of claim 1 wherein the active region is comprised of quantum dots.

9. The apparatus of claim 1 wherein the active region is comprised of quantum dots that are comprised of GaAs.

10. The apparatus of claim 1 wherein the optical output of the apparatus is optically coupled to an optical waveguide which is optically coupled to a modulator which is optically coupled to a multiplexer.

11. The apparatus of claim 10 wherein the apparatus, the modulator, and the multiplexer are disposed on an integrated circuit chip.

12. An apparatus comprising,
an optical waveguide structure,
a light-emitting region comprised of semiconductor material that is capable of emitting light in response to the input of electrical energy, wherein the light-emitting region is optically coupled to the waveguide so that the light-emitting region is capable of transmitting light to the optical waveguide, and
a first separate confinement heterostructure layer between the optical waveguide and the light-emitting region and a second separate confinement heterostructure layer proximate to the light-emitting region and on an opposite side of the light-emitting region from the first separate confinement heterostructure layer,
wherein the first separate confinement heterostructure layer, the light-emitting region, and the second separate confinement heterostructure layer make up an active region of the laser and the active region has a thickness in the range of 40 nm to 400 nm.

13. The apparatus of claim 12 wherein the waveguide structure is comprised of silicon.

14. The apparatus of claim 12 additionally including a cladding region proximate to the active region and on a side of the active region opposite the optical waveguide wherein the cladding region partially defines a path for current flow between the active region and an external source of voltage.

15. The apparatus of claim 14 wherein the path for current flow is defined by boundaries of the cladding region and not by a hydrogen implant region that is part of the cladding region.

16. The apparatus of claim 14 also including and an electrical connection layer between the active region and the optical waveguide wherein the electrical connection layer further defines the path for current to flow between the active region and an external source of voltage.

17. The apparatus of claim 12 wherein the active region is comprised of multiple quantum wells.

18. The apparatus of claim 12 wherein the active region is comprised of multiple quantum wells that are comprised of InGaAs, AlGaAs, or InAlGaAs.

19. The apparatus of claim 12 wherein the active region is comprised of quantum dots.

20. The apparatus of claim 12 wherein the active region is comprised of quantum dots that are comprised of GaAs.

21. The apparatus of claim 12 wherein the active region has a thickness in the range of 50 nm and 340 nm.

22. The apparatus of claim 12 wherein the light-emitting region has a thickness in the range of 7 nm and 80 nm.

23. The apparatus of claim 12 wherein the index of refraction for the active region is between and including 3.3 to 3.5.

24. The apparatus of claim 12 wherein the optical output of the apparatus is optically coupled to an optical waveguide which is optically coupled to a modulator which is optically coupled to a multiplexer.

25. The apparatus of claim 24 wherein the apparatus, the modulator, and the multiplexer are disposed on an integrated circuit chip.

26. An apparatus comprising,
an optical waveguide structure,
a light-emitting region comprised of quantum dots that are comprised of gallium arsenide wherein the light-emitting region is capable of emitting light in response to the input of electrical energy, wherein the light-emitting region is optically coupled to the waveguide so that the light-emitting region is capable of transmitting light to the optical waveguide,
a cladding region proximate to the light-emitting region and on a side of the light-emitting region opposite the optical waveguide wherein the cladding region defines a first path for current flow between the active region and an external source of voltage, and
an electrical connection layer between the active region and the optical waveguide wherein the electrical connection layer defines a second path for current to flow between the active region and an external source of voltage.

27. The apparatus of claim 26 wherein the electrical connection layer is comprised of an N-type gallium arsenide.

28. The apparatus of claim 26 wherein the apparatus does not include a layer of metal between (a) a structure comprised in part of the light-emitting region and the electrical connection layer and (b) the waveguide structure.

29. The apparatus of claim 15 wherein boundary regions in the cladding region define the first path for current flow wherein the boundary regions are capable of preventing current flow and the boundary regions are comprised of cladding material that comprises implanted protons.
